(19) United States
(12) Patent Application Publication
(10) Pub. No.: US 2021/0187721 A1
(43) Pub. Date: Jun. 24, 2021

(54) VIBRATION-DAMPED HAND-HELD POWER TOOL

(71) Applicant: Hilti Aktiengesellschaft, Schaan (LI)

(72) Inventor: Adrian STEINGRUBER, Schwabmuenchen (DE)

(21) Appl. No.: 16/757,737

(22) PCT Filed: Nov. 21, 2018
(86) PCT No.: PCT/EP2018/082028

§ 371 Date: Apr. 20, 2020

(30) Foreign Application Priority Data
Dec. 19, 2017 (EP) 17208325.5

(51) Int. Cl. B25F 5/00; B25D 17/24

(52) U.S. Cl. CPC B25F 5/006; B25D 2250/371; B25D 17/24

(57) ABSTRACT

An electric hand-held power tool (100), in particular a hammer drill or chipping hammer, having a percussion mechanism assembly (10), which vibrates along a vibration axis (A), and a handle assembly (20), which is vibrationally decoupled via an anti-vibration unit (30), wherein the anti-vibration unit (30) has a coil spring (35), oriented along the vibration axis (A), having a plurality of turns, wherein the coil spring (35) is in the form of a cylindrically progressive compression spring (36) having two stiffness regions (S1, S2) with different levels of stiffness.

The present invention relates to an electric hand-held power tool having a percussion mechanism assembly, which vibrates along a vibration axis, and a handle assembly, which is vibrationally decoupled via an anti-vibration unit, wherein the anti-vibration unit has a coil spring, oriented along the vibration axis, having a plurality of turns. A hand-held power tool of this kind is known for example from DE 10 2007 000 270 A1.

### BACKGROUND

The object of the present invention is to provide a hand-held power tool, the vibration of which is ideally reduced in the range of medium to high contact pressures compared with the prior art, in particular without it being necessary to provide a relatively large spring travel in structural terms for this purpose.

### SUMMARY OF THE INVENTION

It is an object of the present invention that the coil spring is in the form of a cylindrically progressive compression spring having two stiffness regions with different levels of stiffness.

In contrast to hand-held power tools known from the prior art, it is possible in this way to achieve a non-linear spring characteristic of the coil spring in a structurally simple and cost-effective way. In particular, the anti-vibration unit is free of a threaded mandrel on which the coil spring is at least locally screwed.

Since, according to the invention, the coil spring is in the form of a cylindrically progressive compression spring having two stiffness regions with different levels of stiffness, a comparatively simple adaptation of the stiffness profile is also possible, specifically merely by exchanging the coil spring itself.

In a particularly preferred configuration, the coil spring provided as a cylindrically progressive compression spring is configured in a progressive manner on one side. Preferably, the stiffness region with the higher stiffness sequentially follows the stiffness region with the low stiffness.

In a further preferred configuration, the coil spring provided as a cylindrically progressive compression spring is configured in a progressive manner on both sides, and has preferably a third stiffness region.

It has been found to be advantageous when the third stiffness region has the same stiffness as the stiffness region with the lower stiffness. Preferably, the stiffness region with the higher stiffness lies, along the vibration axis, between the stiffness regions with the respectively lower stiffness.

It has been found to be particularly advantageous when the stiffness regions with the respectively low stiffness exhibit the same length along the vibration axis. Alternatively or additionally, with the compression spring unloaded, the stiffness regions with the respectively lower stiffness may be shorter along the vibration axis than a length of the stiffness region with the higher stiffness.

Particularly preferably, the compression spring has a constant outside diameter. Preferably, the compression spring has, in the unloaded state, a length of between 65 and 75 mm. Particularly preferably, the compression spring 66 has an outside diameter of between 19 and 23 mm.

Further advantages will become apparent from the following description of the figures. The figures illustrate various exemplary embodiments of the present invention. The figures, the description and the claims contain numerous features in combination. A person skilled in the art will expediently also consider the features individually and combine them to produce expedient further combinations.

### BRIEF DESCRIPTION OF THE DRAWINGS

Identical components and components of identical type are designated by identical reference signs in the figures, in which:

FIG. 1 shows a schematic illustration of a first preferred exemplary embodiment of an electric hand-held power tool;

FIG. 2 shows a schematic illustration of the progressive compression spring of the hand-held power tool in FIG. 1;

FIG. 3 shows an alternative configuration of a cylindrically progressive compression spring;

FIG. 4 shows the progressive compression spring in FIG. 3 in different loading states;

FIG. 5 shows different technical characteristics of the progressive compression spring in FIGS. 3 and 4;

FIG. 6 shows further structural details of the progressive compression spring in FIGS. 3 and 4; and

FIG. 7 shows a spring characteristic curve of the progressive compression spring in FIGS. 3 and 4.

### DETAILED DESCRIPTION

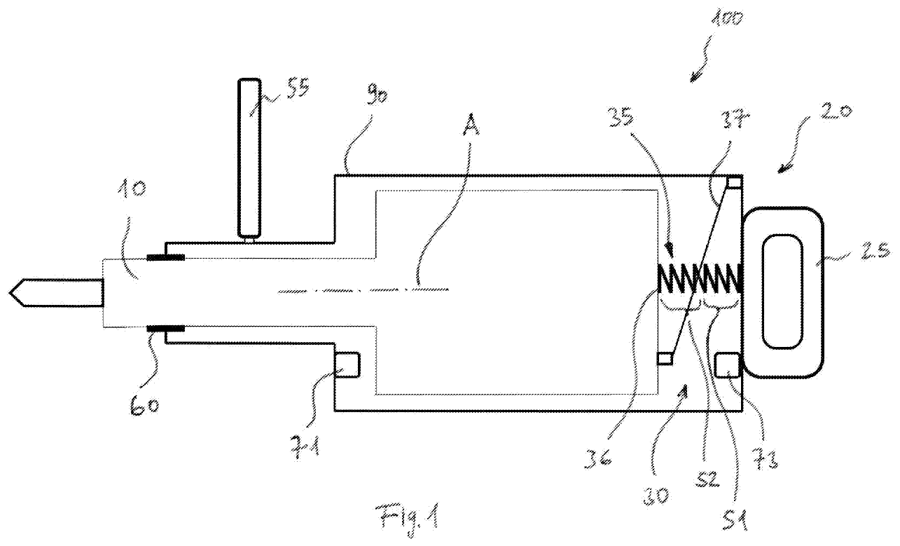

A preferred exemplary embodiment of an electric hand-held power tool 100 is shown in FIG. 1. By way of example, the electric hand-held power tool 100 is provided in the form of a hammer drill. The hand-held power tool 100 has a percussion mechanism assembly 10, which vibrates along the vibration axis A. The percussion mechanism assembly 10 comprises an electric motor and a transmission, which are not illustrated here.

The electric hand-held power tool 100 also has a handle assembly 20, which is vibrationally decoupled via an anti-vibration unit 30. The anti-vibration unit 30 for its part has a coil spring 35, oriented along the vibration axis A, having a plurality of turns.

As can be gathered from FIG. 1, the percussion mechanism assembly 10 is mounted in a sliding manner via a sliding guide 60 in a housing unit 90 of the hand-held power tool 100.

The housing 90 can for its part be handled via a rear handle 25 and a front handle 55.

In the region of the anti-vibration unit 30, the percussion mechanism assembly 10 is connected to the housing unit 90 via an articulated arm 37 such that the percussion mechanism assembly 10 can move along the vibration axis A.

With respect to its movement along the vibration axis A, the movement of the percussion mechanism assembly 10 is limited by a front bump stop 70 and a rear bump stop 73.

According to the invention, the coil spring 35 is in the form of a cylindrically progressive compression spring 36 having two stiffness regions S1, S2 with different levels of stiffness.

In the exemplary embodiment in FIG. 1, the coil spring 35 provided as a cylindrically progressive compression spring 36 is configured in a progressive manner on one side, wherein the stiffness region S2 with the higher stiffness sequentially follows the stiffness region S1 with the lower stiffness.

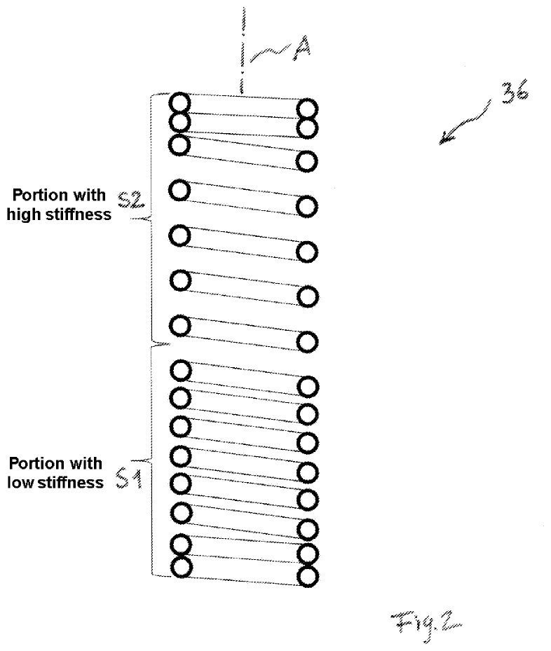

In FIG. 2, the cylindrically progressive compression spring 36 in FIG. 1 is illustrated in detail. It is readily apparent that the cylindrically progressive compression spring 36 has two stiffness regions S1, S2, which—with respect to the vibration axis—sequentially follow one another. In this case, the two stiffness regions S1, S2 have different levels of stiffness. The first stiffness region S1 has a lower stiffness than the second stiffness region S2.

In the unloaded state, shown in FIG. 2, of the compression spring 36, the two stiffness regions S1, S2 exhibit the same length along the vibration axis A.

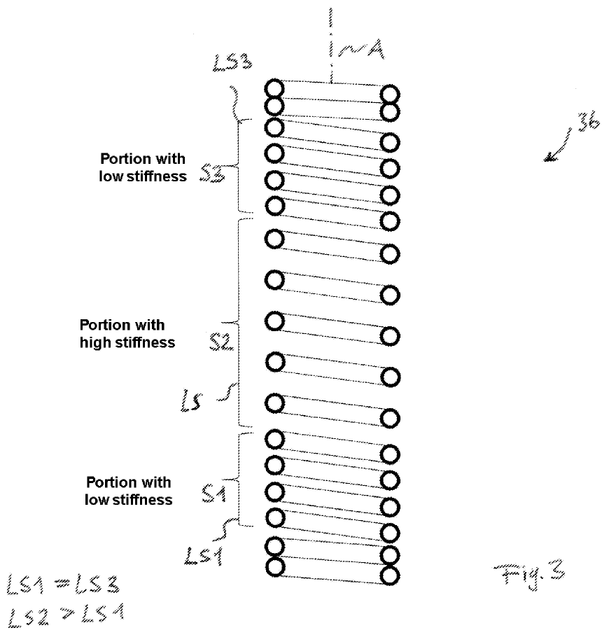

A cylindrically progressive compression spring 36 that is configured in a progressive manner on both sides is illustrated in FIG. 3. The compression spring 36 in FIG. 3 has three stiffness regions S1, S2, S3.

In the case of the compression spring 36 in FIG. 3, too, two stiffness regions with different levels of stiffness are formed, specifically the first stiffness region S1 and the second stiffness region S2. The first stiffness region S1 has a lower stiffness than the second stiffness region S2 having a high stiffness.

The third stiffness region S3 has the same stiffness as the first stiffness region S1, and so both the first stiffness region S1 and the second stiffness region S3 each have a lower stiffness than the middle, second stiffness region S2.

It is likewise readily apparent from FIG. 3 that the stiffness region S2 with the higher stiffness is located, along the vibration axis A, between the stiffness regions S1, S2 with the respectively low stiffness.

The stiffness regions S1, S3 with the respectively lower stiffness exhibit the same length LS1, LS3 along the vibration axis A. This has the advantage that the risk of kinking of the cylindrical compression spring 36 configured in a progressive manner on both sides is reduced.

In the exemplary embodiment in FIG. 3, it is likewise the case that, with the compression spring 36 unloaded, the stiffness regions S1, S3 with the respectively low stiffness are shorter along the vibration axis A than a length LS2 of the stiffness region S2 with the higher stiffness. The compression spring 36 has a constant outside diameter.

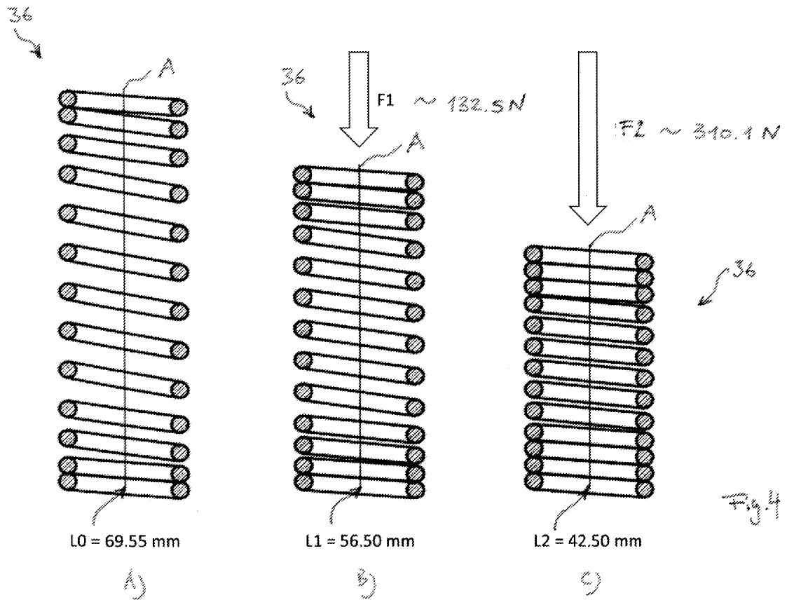

With reference to FIG. 4, various states of a preferred structural exemplary embodiment of a compression spring 36 that is progressive on both sides will now be explained. Here, FIG. 4A shows the compression spring 36 in an unloaded state. For example, a nominal length of the compression spring 36 is about 69.55 mm.

FIG. 4B shows the state of the compression spring 36 in an installed and non-actuated state. The nominal length L1 of the unloaded compression spring 36 is about 56.50 mm, and the associated spring force F1 for the non-actuated state is about 132.5 N.

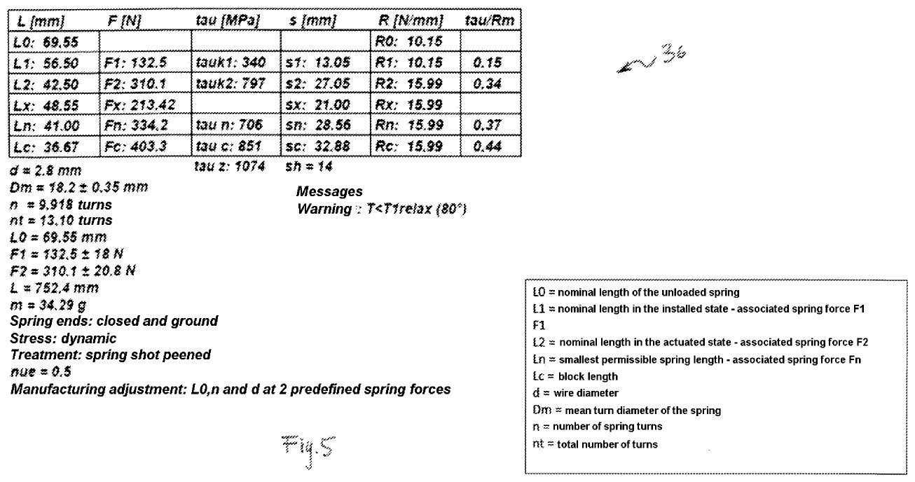

FIG. 4C shows finally the compression spring 36 in an installed and actuated state. The nominal length L2 is in this case about 42.5 mm with an associated spring force F2 of about 310.1 N. FIG. 5 shows further technical characteristics of the particularly preferred compression spring 36 that is progressive on both sides from FIG. 4. The nominal lengths L0, L1, L2, and the spring force F1 associated with the nominal length L1 and the spring force F2 associated with the nominal length L2 have already been described with reference to FIG. 4.

In the case of the structurally preferred compression spring 36, a wire diameter d of 2.8 mm and a mean turn diameter of the compression spring 36 Dm of about 18.2 mm should be noted. The number of spring turns n is calculated to be about 9.9 turns. The total number of turns nt is calculated to be about 13.1 turns.

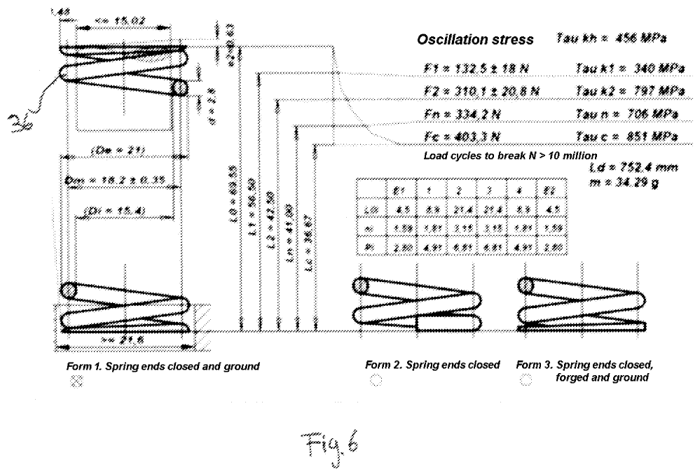

FIG. 6 shows finally a characteristic spring diagram for the preferred cylindrically progressive compression spring 36, which is configured in a progressive manner on both sides and has three stiffness regions. In particular, the relationship between the respective nominal lengths L0, L1, L2 and the associated oscillation stresses F1, F2 etc. are discernible here.

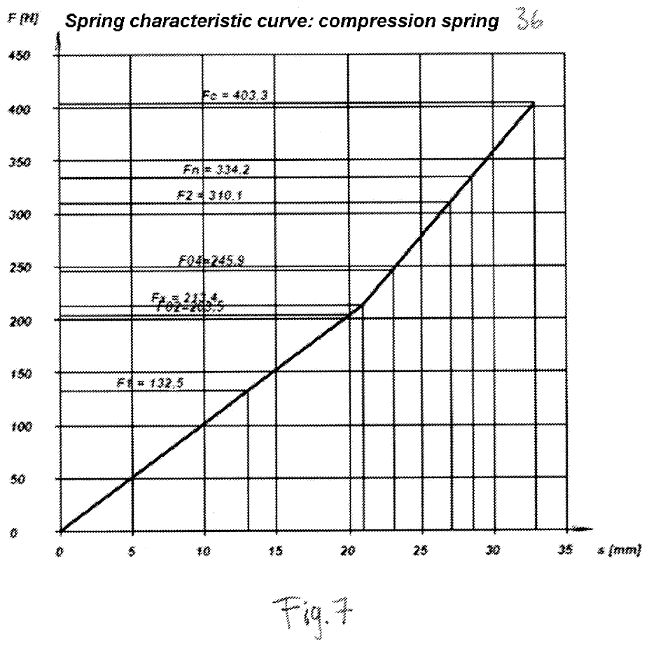

FIG. 7 illustrates finally the spring characteristic curve of the preferred compression spring 36 in FIGS. 3 to 6. In this case, an oscillation stress F in N is plotted with respect to the spring travel s in mm. It is readily apparent that the spring characteristic curve rises linearly up to an oscillation stress Fx of about 213.42 N and then kinks from this point (kink of the spring characteristic curve) to a steeper spring characteristic curve portion. The spring characteristic curve of the compression spring 36 thus exhibits a progressive behavior overall.

### LIST OF REFERENCE SIGNS

10 Percussion mechanism assembly with motor and transmission
20 Handle assembly
25 Rear handle
30 Anti-vibration unit
35 Coil spring
36 Compression spring
37 Articulated arm
55 Front handle
60 Sliding guide
71 Front bump stop
73 Rear bump stop
90 Housing unit
100 Hand-held power tool
A Vibration axis
L0 Nominal length of the compression spring in an unloaded state
L1 Nominal length of the unloaded in an installed and non-actuated state
L2 Nominal length of the unloaded compression spring in an installed and actuated state
LS1 Length of the first stiffness region
LS2 Length of the second stiffness region
LS3 Length of the third stiffness region
S1 First stiffness region
S2 Second stiffness region
S3 Third stiffness region

What is claimed is:

1-9. (canceled)

10: An electric hand-held power tool comprising:
a percussion mechanism assembly vibrating along a vibration axis; and
a handle assembly vibrationally decoupled via an anti-vibration unit, wherein the anti-vibration unit has a coil spring oriented along the vibration axis, the coil spring having a plurality of turns, the coil spring being in the form of a cylindrically progressive compression spring having a first stiffness region and a second stiffness region with different levels of stiffness.

11: The hand-held power tool as recited in claim 10 wherein the cylindrically progressive compression spring is configured in a progressive manner on one side, wherein the second stiffness region with a higher stiffness sequentially follows the first stiffness region with a lower stiffness.

12: The hand-held power tool as recited in claim 10 wherein the cylindrically progressive compression spring is configured in a progressive manner on both sides, and has a third stiffness region.

13: The hand-held power tool as recited in claim 12 wherein the second stiffness region with a higher stiffness sequentially follows the first stiffness region with a lower stiffness and wherein the third stiffness region has a same stiffness as the first stiffness region.

14: The hand-held power tool as recited in claim 12 wherein the second stiffness region lies, along the vibration axis, between the first and third stiffness regions, the first and third stiffness regions having lower stiffnesses than the second stiffness region.

15: The hand-held power tool as recited in claim 14 wherein the first and third stiffness regions exhibit a same length along the vibration axis.

16: The hand-held power tool as recited in claim 14 wherein, with the compression spring unloaded, the first and third stiffness regions are shorter along the vibration axis than a length of the second stiffness region.

17: The hand-held power tool as recited in claim 12 wherein, with the compression spring unloaded, the first and third stiffness regions have a lower stiffness than the second stiffness region and are shorter along the vibration axis than a length of the second stiffness region.

18: The hand-held power tool as recited in claim 13 wherein the first and third stiffness regions exhibit a same length along the vibration axis.

19: The hand-held power tool as recited in claim 13 wherein, with the compression spring unloaded, the first and third stiffness regions are shorter along the vibration axis than a length of the second stiffness region.

20: The hand-held power tool as recited in claim 10 wherein the compression spring has a constant outside diameter.

21: The hand-held power tool as recited in claim 10 wherein the anti-vibration unit is free of a coil spring threaded mandrel.

22: A hammer drill comprising the hand-held power tool as recited in claim claim 10.

23: A chipping hammer comprising the hand-held power tool as recited in claim 10.
